(19) United States
(12) Patent Application Publication
(10) Pub. No.: US 2022/0382803 A1
(43) Pub. Date: Dec. 1, 2022

(54) Syndication of Secondary Digital Assets with Photo Library

(71) Applicant: Apple Inc., Cupertino, CA (US)

(72) Inventors: Kalu O. Kalu, Los Gatos, CA (US); Akarsh Simha, Sunnyvale, CA (US); Kevin Aujoulet, San Francisco, CA (US); Marcelo Lotif Araujo, Campbell, CA (US); Rohan Chandra, San Francisco, CA (US); Pamela Chen, Cupertino, CA (US); Elisa Y. Cui, San Mateo, CA (US); Kamal Benkiran, San Francisco, CA (US)

(21) Appl. No.: 17/657,024

(22) Filed: Mar. 29, 2022

Related U.S. Application Data
(60) Provisional application No. 63/195,491, filed on Jun. 1, 2021.

(51) Int. Cl. G06F 16/55

(52) U.S. Cl. CPC G06F 16/55

(57) ABSTRACT

This disclosure relates to systems, methods, and computer-readable media for identifying digital assets on the end-user device and received from another device as the secondary digital assets; adding the secondary digital assets to a syndication library separate from the primary photo library; and applying eligibility filters to the secondary digital assets in the syndication library, the eligibility filters resulting in a set of eligible secondary digital assets in the syndication library and a set of ineligible secondary digital assets in the syndication library. The set of eligible secondary digital assets in the syndication library are linked with the primary photo library.

### TECHNICAL FIELD

This disclosure relates generally to the field of digital asset (DA) management for an end-user device in a networked environment. More particularly, the disclosure relates to systems and processes for managing syndication of secondary DAs with the primary photo library of an end-user device.

### BACKGROUND

Modern consumer electronics (end-user devices) have enabled users to create, purchase, and amass considerable amounts of digital assets (DAs) (e.g., images, videos, music, etc.). For example, a computing systems (e.g., a smartphone, a stationary computer system, a portable computer system, a media player, a tablet computer system, a wearable computer system or device, etc.) routinely have access to tens of thousands and even hundreds of thousands of DAs, and collections of DAs, which include hundreds or thousands of DAs.

The DAs obtained by end-user devices include two categories of DAs: primary DAs; and secondary DAs. Primary DAs are captured by sensors (e.g., cameras, microphones, etc.) included with the end-user device, external sensors coupled to the end-user device (e.g., an external web camera, specialty camera, etc.), or are obtained from trusted sources associated with the user (e.g., the photo library of the user's cloud account; the photo library of the user's computer, laptop, or other display device; direct imports from cameras, memory cards, scanners or other devices; imports from end-user devices that are previously identified as a trusted source by a user; and/or any other trusted sources). Primary DAs are automatically added to a primary photo library of an end-user device. The primary photo library provides various options to query, organize, and highlight DAs. Secondary DAs are received by the end-user device from other users' devices via a wired or wireless communication interface, or from other secondary sources (e.g., any application on the end-user device which can receive DAs; the photo library of another user's end-user device; imports from end-user devices that are not previously identified as a trusted source by a user). Secondary DAs are not automatically added to the primary photo library of an end-user device. It is also possible to vary the designation of primary DAs and secondary DAs for different users. In general, on modern end-user devices, the number of DAs received from messaging applications of the end-user device is increasing and presents an ongoing challenge. Manual adjustments (e.g., adding DAs from messaging apps to the user's primary photo library, or assigning the status of a DA as primary or secondary) is possible, however, these manual options may be undesirably time-intensive.

### SUMMARY

Methods, computer-readable media and systems for syndication of secondary digital assets (DAs) with the primary photo library of an end-user device are described herein. With the described methods, computer-readable medium and systems, syndication of secondary DAs with the primary photo library of an end-user device is performed subject to a set of one or more eligibility filters. The secondary DAs that comply with the eligibility filters may be linked with the primary photo library. In one example, linking eligible secondary DAs with the primary photo library includes updating a knowledge graph or linking different knowledge graphs. After linking the eligible secondary DAs with the primary photo library, the eligible secondary DAs may be displayed in the primary photo library and/or become searchable using the updated knowledge graph. As desired, various options provided by the primary photo library to organize DAs and/or offer particular user experiences featuring particular DAs are then able to include the eligible secondary DAs.

Without limitation, example eligibility filters include: applying scores to the secondary digital assets in the syndication library, the scores providing an indication of quality relative to at least one quality metric; identifying a first set of secondary digital assets in the syndication library with scores above a threshold; and identifying a second set of secondary digital assets in the syndication library with scores at or below the threshold. The second set of secondary digital assets becomes part of a set of ineligible secondary digital assets in the syndication library. In some example embodiments, the applied scores account for an aesthetic quality metric and a document or meme exclusion metric. Additionally or alternatively, applying eligibility filters to the secondary digital assets in the syndication library includes applying a file type filter and/or a workplace eligibility filter. Additionally or alternatively, applying the eligibility filters to the secondary digital assets in the syndication library includes matching digital asset identifiers or metadata identifiers with predetermined identifiers associated with digital assets already in the primary photo library. Example predetermined identifiers include faces, pets, locations, and times.

### BRIEF DESCRIPTION OF THE DRAWINGS

Embodiments described herein are illustrated by examples and not limitations in the accompanying drawings, in which like references indicate similar features. Furthermore, in the drawings, some conventional details have been omitted, so as not to obscure the inventive concepts described herein.

FIG. 1 illustrates, in block diagram form, a digital asset (DA) management system that includes electronic components for performing DA management that includes syndication of secondary DAs with the primary photo library of an end-user device in accordance with an embodiment.

FIG. 2 illustrates, in block diagram form, a system with networked end-user devices in accordance with an embodiment.

FIG. 3 illustrates, in block diagram form, a knowledge graph update architecture, in accordance with an embodiment.

FIG. 4 illustrates, in block diagram form, a primary photo library scenario, in accordance with an embodiment.

FIG. 5 illustrates, in flowchart form, a method of managing syndication of secondary digital assets with a primary photo library of an end-user device in accordance with an embodiment.

FIG. 6 illustrates a simplified functional block diagram of illustrative programmable electronic device for DA management in accordance with an embodiment.

### DETAILED DESCRIPTION

Described herein are methods, end-user devices, computer-readable media, and systems for managing syndication of secondary digital assets (DAs) with the primary photo library of an end-user device. With the described syndication techniques, secondary DAs are automatically linked to the primary photo library, subject to the application of a set of one or more eligibility filters. With the described secondary DA syndication management, external photos and videos are selectively allowed to participate in the primary photo library of an end-user device. The eligible secondary DAs and regular DAs (also referred to as “primary DAs” herein) may be utilized with primary photo library features, such as: a “Memory” digital presentation feature; a DA highlight feature (e.g., a key photo or cover photo); and/or other features. The syndication management options described herein cover the algorithms and techniques to automate syndication of secondary DAs (i.e., smart syndication of secondary DAs). The eligible secondary DAs are granted a privilege (e.g., participation in the primary photo library) that other secondary DAs are not granted. In some embodiments, smart syndication of secondary DAs with the primary photo library is based on the follow criteria: 1) filtering to eliminate secondary DAs deemed to be lower quality; and 2) DA content promotion. The combined smart syndication criteria are referred to herein as eligibility filters, which are applied to secondary DAs by a DA management system.

### Terminology

In order to enhance understanding of this disclosure and the various embodiments discussed, non-limiting explanations of various terms used in this disclosure are provided below.

Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

The term “digital asset” (DA) refers to data/information which is bundled or grouped in such a way as to be meaningfully rendered by a computational device for viewing, reading, and/or listening by a person or other computational device/machine/electronic device. Digital assets can include photos, recordings, and data objects (or simply “objects”), as well as video files and audio files. Image data related to photos, recordings, data objects, and/or video files can include information or data necessary to enable an electronic device to display or render images (such as photos) and videos. Audiovisual data can include information or data necessary to enable an electronic device to present videos and content having a visual and/or auditory component.

The term “primary DAs” refers to DAs captured using native sensors (e.g., cameras, microphone, etc.) of an end-user device, external sensors coupled to the end-user device (e.g., an external web camera, specialty camera, etc.), or DAs obtained from trusted sources associated with the user (e.g., the photo library of the user's cloud account; the photo library of the user's computer, laptop, or other display device; direct imports from cameras, memory cards, scanners or other devices; imports from end-user devices that are previously identified as a trusted source by a user; and/or any other trusted sources).

The term “secondary DAs” refers to DAs captured by another end-user device and received later by a given end-user device (e.g., via a wired or wireless communication interface). Secondary DAs may alternatively be termed “external DAs” or “guest DAs”. Secondary DAs are received by the end-user device from other users' devices via a wired or wireless communication interface, or from other secondary sources (e.g., any application on the end-user device which can receive DAs; the photo library of another user's end-user device; imports from end-user devices that are not previously identified as a trusted source by a user).

The term “DA management” refers to methods and procedures for managing DAs. A DA management system is thus a system for managing DAs.

The term “primary photo library” refers to a user interface for interacting with DAs including photos, videos, enhanced photos (e.g., Apple's Live Photos), songs, or other DAs (i.e., the primary photo library is not just “photos,” per se. As an example, the primary photo library may provide a variety of query, organization, and featured DA options for primary DAs by default. Secondary DAs become linked to the primary photo library after a syndication process subject to eligibility filters. In different scenario, DAs in the primary photo library may be stored locally, at a server, or a combination thereof. In some scenarios, users with “iCloud Storage” turned on will have most of the high/full-resolution versions of their primary photo library stored in cloud storage. Just thumbnails are stored locally on the end-user device. As a user scrolls through or accesses certain photos, the full-resolution versions of the photos can be being downloaded in the background, so that, when a user clicks on the thumbnail, the full-resolution versions of the photos appear.

The term “syndication library” refers to a DA interface separate from the primary photo library. The syndication library stores secondary DAs, which are subject to eligibility filters before becoming linked with primary photo library.

The term “change,” when used as a verb, refers to: making the form, nature, content, future course, etc., of (something) different from what it is or from what it would be if left alone; transforming or converting; and substituting another or others. “Change” includes becoming different, altered and/or modified. When used as a noun, “change” includes the act or fact of changing; fact of being changed; a transformation or modification; alteration; a variation or deviation.

The term “detect” means to notice, note, identify by a computational device such as by one or more processors, either mediately (e.g., via one or more coupled sensors, other devices) or immediately. For example, a system can detect that information in a database has been changed (e.g., updated, revised, altered, or overwritten).

The term “data” refers to information which can be stored by a computer memory. Digital data can be notionally grouped with other digital data to form a DA. Data can include media assets and “image data.”

The term “data object” can be a variable, a data structure, a function, or a method, and a value in computer-readable memory referenced by an identifier. “Data object” or just “object” can refer to a particular instance of a class, where the object can be a combination of variables, functions, and data structures. An object can be a table or column, or an association between data and a database entity (such as relating a person's age to a specific person); an object can thus be a constellation of data describing, for example, a person or an event, or series of events.

The term “computational intensity” refers to the number of computations and/or the amount of time required to perform one or more operations. An operation can be computationally intense or computationally expensive when it would take a relatively large amount of time and/or large number of calculations or computations to carry out the operation.

The expression “modifying information” includes changing, deleting, adding and moving information or data within data storage units, such as databases and computer memory.

The term “electronic device,” (or simply “device”) includes servers, mobile electronic devices such as smart phones, laptop computers, personal computers and tablet computers. These mobile electronic devices are examples of end-user devices.

The term “coupled” refers to components or devices which are able communicate or interact with one another, either directly or indirectly. All connected elements are coupled, but not all coupled elements are connected. Coupled elements include those which are able to communicate with each other.

The terms “determine” and “determination” include, by way of example, calculations, evaluations, ascertainments, confirmations and computations, as well as computations/calculations necessary to make an evaluation, confirmation, ascertainment, or discernment, performed by a computing device, such as a processor. Thus, for example, making a determination as to whether to translate a change in data into one or more modification instructions will involve one or more computations and/or calculations.

The term “knowledge graph” (also called “metadata network”) refers to a data structure with nodes and edges. “Node” is a synonym for “vertex.” Vertices of graphs are often considered to be atomistic objects, with no internal structure. An edge is (together with vertices) one of the two basic units out of which graphs are constructed. Each edge has two (or in hypergraphs, more) vertices to which it is attached, called its endpoints. Edges may be directed or undirected; undirected edges are also called lines and directed edges are also called arcs or arrows. In an undirected simple graph, an edge may be represented as the set of its vertices, and in a directed simple graph it may be represented as an ordered pair of its vertices. An edge that connects vertices x and y is sometimes written xy.

A knowledge graph according to this disclosure can be a graph database. A graph database is a database that uses graph structures for semantic queries with nodes, edges and properties to represent and store data. A key concept of the system is the graph (or edge or relationship), which directly relates data items in a store, (such a relational database). The relationships allow data in the store to be linked together directly, and in many cases retrieved with one operation. Graph databases are based on graph theory, and employ nodes and edges. Graph databases enable simple and fast retrieval of complex hierarchical structures that are difficult to model in relational systems. A knowledge graph allows data elements to be categorized for large scale easy retrieval.

Within the knowledge graph, “nodes” represent entities such as people, businesses, accounts, events, locations or any other item to be tracked. “Edges,” also termed graphs or relationships, connect nodes to other nodes. Edges represent a relationship between nodes. Meaningful patterns emerge when examining the connections and interconnections of nodes, properties, and edges. Edges are key to the knowledge graph, as they represent an abstraction that is not directly implemented in other systems, such a relational database. A change a relational database can necessitate the need to add, delete, or modify one or more nodes and edges in a related knowledge graph. For the described DA management systems, one or more knowledge graphs may be used before, during, and after syndication operations to handle primary DA and secondary DA management options.

The term “relational database” refers to databases that gather data together using information in the data. Relational databases do not inherently contain the idea of fixed relationships between data items, (also called “records”). Instead, related data is linked to each other by storing one record's unique key in another record's data. A relational system may have to search through multiple tables and indexes, gather large amounts of information, and then sort the information to cross-reference data items. In contrast, graph databases directly store the relationships between records.

Described herein are methods, end-user devices, computer-readable media, and systems for managing syndication of secondary DAs with the primary photo library of an end-user device. With the described syndication techniques, secondary DAs are automatically linked to the primary photo library subject to eligibility filters. In some example embodiments, linking eligible secondary DAs with the primary photo library involves: 1) updating a knowledge graph associated with the primary photo library; or 2) linking multiple knowledge graphs (e.g., a first knowledge graph associate with a primary photo library with primary DAs and a second knowledge graph associated with a syndication library with secondary DAs). Once the eligible secondary DAs are linked with the primary photo library, they become searchable within the primary photo library. Also, the updated knowledge graph or linked knowledge graphs enable the eligible secondary DAs to be compatible with organization and featured DA options of the primary photo library. In different example embodiments, the eligibility filters used to syndicate secondary DAs with the primary photo library of an end-user device may vary. Without limitation, the eligibility filters may apply filters to secondary DAs based on an aesthetic quality metric, a text or meme exclusion metric, a file type filter, a workplace eligibility filter, matching secondary DA identifiers with DA identifiers already associated with the primary photo library, matching of secondary DA metadata identifiers with DA metadata identifiers already associated with the primary photo library, or other filtration options.

Embodiments set forth herein can assist with improving computer functionality by enabling management and timing of complex changes to a knowledge graph, thereby improving the ability of users to have timely access to accurate explicit relational information which is only implicit (and hence not easily searchable) within a corresponding relational database.

Some embodiments of this disclosure are based in object-oriented programming (OOP). OOP refers to a programming paradigm based on the concept of “objects,” which may contain data, in the form of fields, often known as attributes. Objects can contain code, in the form of procedures, often known as methods. A feature of objects is that an object's procedures can access and often modify the data fields of the object with which they are. Within OOP schema, a type is a category. A type is an object with a size, a state, and a set of abilities. Types are defined in order to model a problem to be solved. A class is a definition of a new type, that is, types are made by declaring a class. A class is a collection of variables combined with a set of related functions. Other classes and functions can use a class. Member variables are variables in a class. OOP languages can be class-based, meaning that objects are individual instances of classes, which typically also determine their type.

Substantial computational resources may be needed to manage the DAs in a DA collection (e.g., processing power for performing queries or transactions, computer-readable memory space for storing the necessary databases, etc.). Due to limited storage capacity, DA management for an end-user device may be provided by a remote device (e.g., an external data store, an external server, etc.), where copies of the DAs are stored, and the results are transmitted back to the end-user device having limited storage capacity.

Thus, according to some DA management embodiments, a “knowledge graph” (also referred to herein as a “metadata network”) associated with a collection of digital assets (i.e., a DA collection) is used. The knowledge graph can comprise correlated “metadata assets” describing characteristics associated with DAs. Each metadata asset can describe a characteristic associated with one or more digital DAs in the DA collection. For example, a metadata asset can describe a characteristic associated with multiple DAs in the DA collection, such as the location, day of week, event type, etc., of the one or more associated DAs. Each metadata asset can be represented as a node in the metadata network. A metadata asset can be correlated with at least one other metadata asset. As noted above, correlations between metadata assets can be represented as an edge in the metadata network that is between the nodes representing the correlated metadata assets. According to some embodiments, a knowledge graph may define multiple types of nodes and edges, e.g., each with their own properties, based on the needs of a given implementation.

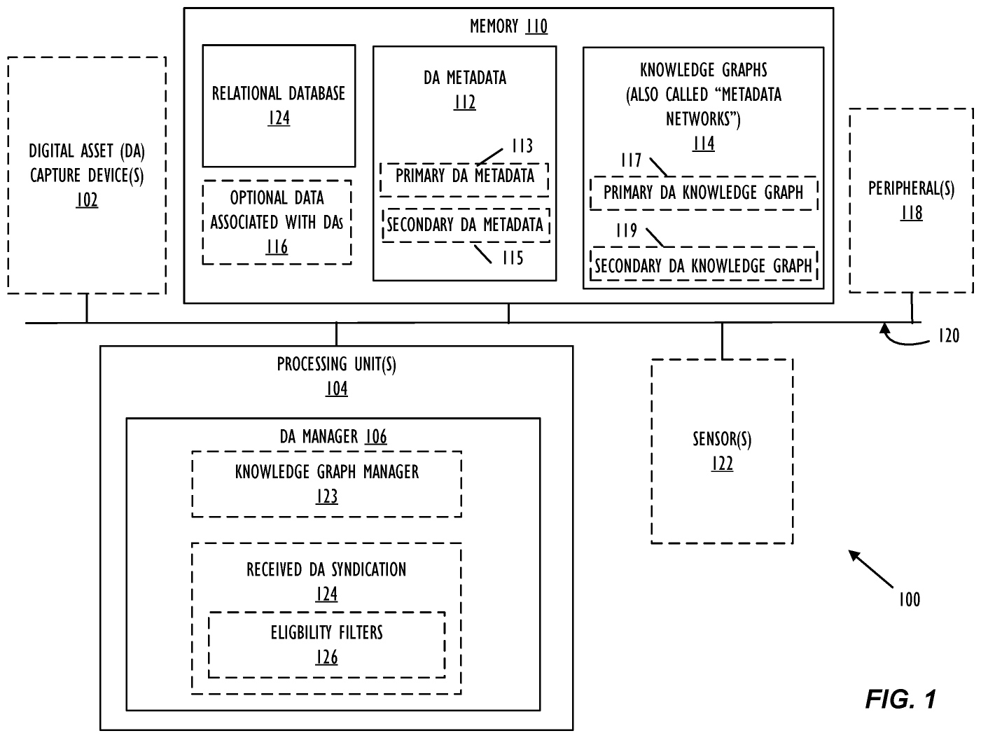

FIG. 1 illustrates, in block diagram form, a DA management system 100 that includes electronic components for performing DA management that includes syndication of secondary DAs with the primary photo library of an end-user device in accordance with one or more embodiments described in this disclosure. The system 100 can be housed in single end-user device, such as a desktop computer system, a laptop computer system, a tablet computer system, a server computer system, a mobile phone, a media player, a personal digital assistant (PDA), a personal communicator, a gaming device, a network router or hub, a wireless access point (AP) or repeater, a set-top box, or a combination thereof. Components in the system 100 can be spatially separated and implemented on separate computing systems that are connected by the communication technology 120, as described in further detail below.

For one embodiment, the system 100 may include processing unit(s) 104, computer-readable memory 110, DA capture device(s) 102, sensor(s) 122, and peripheral(s) 118. For one embodiment, one or more components in the system 100 may be implemented as one or more integrated circuits (ICs). For example, at least one of the processing unit(s) 104, the communication technology 120, the DA capture device(s) 102, the peripheral(s) 118, the sensor(s) 122, or the computer-readable memory 110 can be implemented as a system-on-a-chip (SoC) IC, a three-dimensional (3D) IC, any other known IC, or any known IC combination. For another embodiment, two or more components in the system 100 are implemented together as one or more ICs. For example, at least two of the processing unit(s) 104, the communication technology 120, the DA capture device 102, the peripheral(s) 118, the sensor(s) 122, or the computer-readable memory 110 are implemented together as a SoC IC. Each component of system 100 is described below.

As shown in FIG. 1, the system 100 can include processing unit(s) 104, such as CPUs, GPUs, other integrated circuits (ICs), computer memory, and/or other electronic circuitry. For one embodiment, the processing unit(s) 104 manipulate and/or process DA metadata associated with DAs 112 or optional data 116 associated with digital assets (e.g., data objects reflecting one or more persons, places, and/or events associated with a given DA, etc.). The processing unit(s) 104 may include a DA manager 106 for performing one or more embodiments of DA management, as described herein. For one embodiment, the DA manager 106 is implemented as hardware (e.g., electronic circuitry associated with the processing unit(s) 104, circuitry, dedicated logic, etc.), software (e.g., one or more instructions associated with a computer program executed by the processing unit(s) 104, software run on a general-purpose computer system or a dedicated machine, etc.), or a combination thereof.

The DA manager 106 can enable the system 100 to generate and use knowledge graphs 114 of the DA metadata 112 as a multidimensional network. Knowledge graphs 114 and multidimensional networks that may be used to implement the various techniques described herein are described in further detail in U.S. Non-Provisional patent application Ser. No. 15/391,269, entitled “Notable Moments in a Collection of Digital Assets,” filed Dec. 27, 2016, and hereby incorporated by reference herein.

In one embodiment, the DA manager 106 can perform one or more of the following operations: (i) generate the knowledge graphs 114; (ii) relate and/or present at least two DAs, e.g., as part of a moment, based on the knowledge graphs 114; (iii) determine and/or present interesting DAs in the DA collection to the user as sharing suggestions, based on the knowledge graphs 114 and one or more other criterion; (iv) select and/or present suggested DAs to share with one or more third parties, e.g., based on a contextual analysis; and select and/or present secondary DAs received from one or more third parties for linkage or inclusion with a user's own primary photo library.

Over time, the DA manager 106 obtains or receives a collection of DA metadata 112 including primary DA metadata 113 and secondary DA metadata 115. The primary DA metadata 113 and the secondary DA metadata 115 DAs are stored separately at least initially. The related storage locations may be spatially or logically separated as is known. As used herein, “metadata,” “digital asset metadata,” “DA metadata,” and their variations collectively refer to information about one or more DAs. Metadata can be: (i) a single instance of information about digitalized data (e.g., a time stamp associated with one or more images, etc.); or (ii) a grouping of metadata, which refers to a group comprised of multiple instances of information about digitalized data (e.g., several time stamps associated with one or more images, etc.). There may also be many different types of metadata associated with a collection of DAs. Each type of metadata (also referred to as “metadata type”) describes one or more characteristics or attributes associated with one or more DAs. Further detail regarding the various types of metadata that may be stored in a DA collection and/or utilized in conjunction with a knowledge graphs are described in further detail in U.S. Non-Provisional patent application Ser. No. 15/391,269, which was incorporated by reference above.

As used herein, “context” and its variations refer to any or all attributes of a user's device that includes or has access to a DA collection associated with the user, such as physical, logical, social, and other contextual information. As used herein, “contextual information” and its variations refer to metadata that describes or defines a user's context or a context of a user's device that includes or has access to a DA collection associated with the user. Exemplary contextual information includes, but is not limited to, the following: a predetermined time interval; an event scheduled to occur in a predetermined time interval; a geolocation visited during a particular time interval; one or more identified persons associated with a particular time interval; an event taking place during a particular time interval, or a geolocation visited during a particular time interval; weather metadata describing weather associated with a particular period in time (e.g., rain, snow, sun, temperature, etc.); season metadata describing a season associated with the capture of one or more DAs; relationship information describing the nature of the social relationship between a user and one or more third parties; or natural language processing (NLP) information describing the nature and/or content of an interaction between a user and one more third parties. For some embodiments, the contextual information can be obtained from external sources, e.g., a social networking application, a weather application, a calendar application, an address book application, any other type of application, or from any type of data store accessible via a wired or wireless network (e.g., the Internet, a private intranet, etc.).

Referring again to FIG. 1, for one embodiment, the DA manager 106 uses the DA metadata 112 to generate knowledge graphs 114. As shown in FIG. 1, all or some of the knowledge graphs 114 can be stored in the processing unit(s) 104 and/or the computer-readable memory 110. The knowledge graphs 114 include a primary DA knowledge graph 117 and a secondary DA knowledge graph 119. Each of the primary DA knowledge graph 117 and the secondary DA knowledge graph 119 includes dynamically organized collections of metadata describing one or more DAs (e.g., one or more groups of DAs in a DA collection, one or more DAs in a DA collection, etc.) used by one or more computer systems. In the knowledge graphs 114, there are no actual DAs stored—only metadata (e.g., metadata associated with one or more groups of DAs, metadata associated with one or more DAs, etc.). The knowledge graphs 114, differ from databases because, in general, knowledge graphs 114 enable deep connections between metadata using multiple dimensions, which can be traversed for additionally deduced correlations. This deductive reasoning generally is not feasible in a conventional relational database without loading a significant number of database tables (e.g., hundreds, thousands, etc.). Compared to conventional databases, the knowledge graphs 114 may be viewed, operated, and/or stored using fewer computational resources. Furthermore, the knowledge graphs 114 are dynamic resources that have the capacity to learn, grow, and adapt as new information is added to them. This is unlike databases, which are useful for accessing cross-referred information. While a database can be expanded with additional information, the database remains an instrument for accessing the cross-referred information that was put into it. The knowledge graphs 114 do more than access cross-referenced information—they go beyond that and involve the extrapolation of data for inferring or determining additional data. As alluded to above, the DAs themselves may be stored, e.g., on one or more servers remote to the system 100, with thumbnail versions of the DAs stored in the computer-readable memory 110 and full versions of particular DAs only downloaded and/or stored to the computer-readable memory 110 as needed (e.g., when the user desires to view or share a particular DA). In other embodiments, however, e.g., when the amount of onboard storage space and processing resources of the system 100 is sufficiently large and/or the size of the user's DA collection is sufficiently small, the DAs themselves may also be stored within computer-readable memory 110, e.g., in a separate database, such as in one or more relational databases.

The DA manager 106 may generate the knowledge graphs 114 as a multidimensional network of the DA metadata 112. As used herein, a “multidimensional network” and its variations refer to a complex graph having multiple kinds of relationships. A multidimensional network generally includes multiple nodes and edges. For one embodiment, the nodes represent metadata, and the edges represent relationships or correlations between the metadata. Exemplary multidimensional networks include, but are not limited to, edge-labeled multigraphs, multipartite edge-labeled multigraphs, and multilayer networks.

In one embodiment, the knowledge graphs 114 includes two types of nodes—(i) moment nodes; and (ii) non-moments nodes. As used herein, a “moment” refers a single event (as described by an event metadata asset) that is associated with one or more DAs. For example, a moment may refer to a visit to coffee shop in Cupertino, Calif. that took place on Mar. 26, 2018. In this example, the moment can be used to identify one or more DAs (e.g., one image, a group of images, a video, a group of videos, a song, a group of songs, etc.) associated with the visit to the coffee shop on Mar. 26, 2018 (and not with any other event).

As used herein, a “moment node” refers to a node in a multidimensional network that represents a moment (as is described above). As used herein, a “non-moment node” refers a node in a multidimensional network that does not represent a moment. Thus, a non-moment node may refer to a metadata asset associated with one or more DAs that is not a moment (i.e., not an event metadata asset).

For one embodiment, the edges in the knowledge graphs 114 between nodes represent relationships or correlations between the nodes. For one embodiment, the DA manager 106 updates the knowledge graphs 114 as it obtains or receives new metadata 112 and/or determines new metadata 112 for the DAs in the user's DA collection.

The DA manager 106 can manage DAs associated with the DA metadata 112 using the knowledge graphs 114 in various ways. For a first example, DA manager 106 may use the knowledge graphs 114 to identify and present interesting groups of one or more DAs in a DA collection based on the correlations (i.e., the edges in the knowledge graphs 114) between the DA metadata (i.e., the nodes in the knowledge graphs 114) and one or more criterion. For this first example, the DA manager 106 may select the interesting DAs based on moment nodes in the knowledge graphs 114. In some embodiments, the DA manager 106 may suggest that a user shares the one or more identified DAs with one or more third parties. For a second example, the DA manager 106 may use the knowledge graphs 114 and other contextual information gathered from the system (e.g., the user's relationship to one or more third parties, a topic of conversation in a messaging thread, an inferred intent to share DAs related to one or moments, etc.) to select and present a representative group of one or more DAs that the user may want to share with one or more third parties.

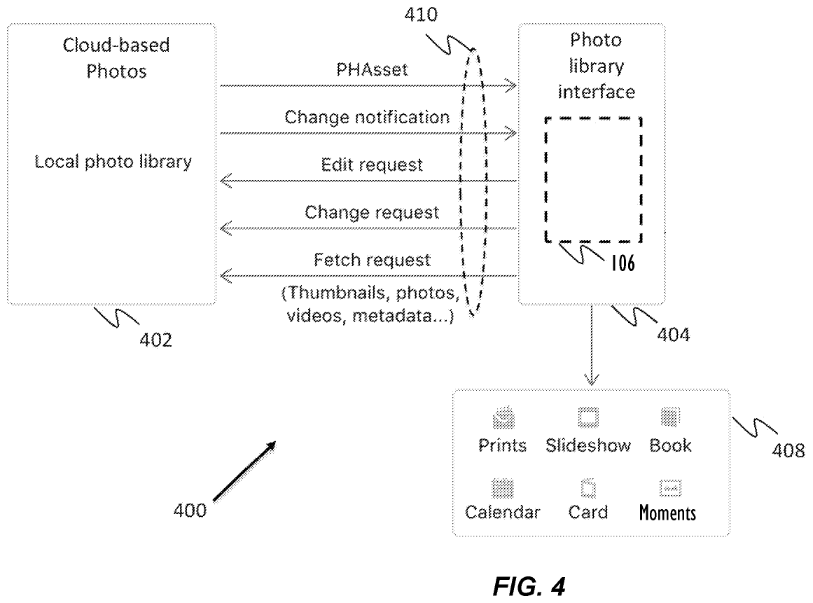

In some example embodiments, the various options related to the knowledge graphs 114 vary for the primary DA knowledge graph 117 versus the secondary DA knowledge graph 119. Specifically, a primary photo library or related interface (see e.g., FIG. 4) is configured to use the primary DA knowledge graph 117 by default. In contrast, the primary photo library or related interface uses the secondary DA knowledge graph 119 in a limited or filtered manner determined by the DA manager 106.

As shown, the DA manager 106 includes secondary DA syndication instructions 124 with eligibility filters 126. With the secondary DA syndication instructions 124, secondary DAs are stored in a syndication library separate from the primary photo library. The secondary DAs in the syndication library are subject to filtration or grouping based on the eligibility filters 126. Once a set of eligible secondary DAs has been identified, these secondary DAs are linked with the primary photo library. This linking is performed, for example, by updating one or more knowledge graphs 114 associated with the primary photo library or by linking multiple knowledge graphs 114.

In some example embodiments, the eligibility filters 126 include a quality filtering stage. The goal of the quality filtering stage is to disallow unfit content from even being considered. In some example embodiments, the quality filtering stage includes a step that analyzes secondary DAs and computes quality scores (e.g., blurriness, receipt, framing, aesthetics, etc.). Such quality scores may also be used within the primary photo library. In some example embodiments, the quality scores identify secondary DAs that are most likely to be memes or documents (e.g., a driver's license, a passport, etc.).

Another step of the quality filtering stage includes computing cumulative curation scores for each secondary DAs based on the individual quality metric scores. Such cumulative curation scores may also be used within the primary photo library. In some example embodiments, the cumulative curation scores are weighted so that memes and documents will automatically be given a poor curation score. With the weighted cumulative curation scores, memes/documents already present in the primary photo library can be avoided for features that highlight particular DAs. Also, the quality filtering stage may apply a hard filter on DAs with cumulative curation scores below a threshold. As an example, secondary DAs that do not receive a cumulative curation score above the threshold (e.g., 0.5) will be fall into the set of ineligible secondary DAs by a DA management system performing syndication of secondary DAs with the primary photo library. To disallow documents and memes, the cumulative curation score for secondary DAs most likely to be documents or memes will fall below the threshold. After the quality filtering stage, remaining secondary DAs will include secondary DAs with an acceptable quality.

Besides the quality filtering stage, the eligibility filters 126 perform a content promotion stage. The goal of the content promotion stage is to further filter out secondary DAs based on various criteria. For example, the content promotion stage may eliminate GIFs, PDFs, and other non-image/video file types. Additionally or alternatively, the content promotion stage may allow only certain file types. Also, some secondary DAs are deemed ineligible based on a workplace eligibility filter separate from the quality filtering stage. There are many possible reasons why a secondary DA is deemed ineligible separate from the quality filtering stage. As an example, a secondary DA from a location known to be sensitive to the user could be found eligible during the quality filtering stage, but ineligible during the content promotion stage. In other words, the content promotion stage may leverage personal context of a user or workplace to filter secondary DAs.

In some example embodiments, the content promotion stage involves analyzing the primary DA knowledge graph 117 and the second DA knowledge graph 119 (e.g., to determine if secondary DAs are related to primary DAs already in the primary photo library). Secondary DAs that pass the quality filter stage and the content promotion stage are deemed eligible secondary DAs. As desired, eligible secondary DAs may be grouped by time/location/sender, or other grouping criteria. At this point, the eligible secondary DAs are associated with or linked to the primary photo library. In some example embodiments, a semantical “de-duping” operation is performed to avoid duplication (to within some measure of similarity) of DAs in the primary photo library.

There are different options for how eligible secondary DAs may be associated with the primary photo library (e.g., displayed in the primary photo library, and available for query, organization, and featured DA options of the primary photo library). In a first option, the primary DA knowledge graph 117 is updated to include information regarding the eligible secondary DAs. In a second option, the secondary DA knowledge graph 119 to identify eligible secondary DAs and a link is provided between the primary DA knowledge graph 117 and the secondary DA knowledge graph 119. Regardless of the particular technique used, the syndication results enable the eligible secondary DAs to be associated with the primary photo library and its related query, organization, and featured DA options.

In some example embodiments, secondary DAs of the user of an end-user device are automatically considered to be eligible secondary DAs for the end-user device of the user. In some example embodiments, a knowledge graph for the primary photo library is used to identify that a secondary DA includes a user's image because the user linked their “Me” contact to their primary photo library. As another option, the knowledge graph may be able to infer who the owner is without explicit user actions. In this case, a person node of the knowledge graph may be used to infer the identity of the user.

In some example embodiments, secondary DAs of a user's children are automatically considered to be eligible receive DAs for the end-user device of the user. Similar to identifying a user, a knowledge graph may be used to explicitly or implicitly identify the user's children. As another option, a parent's secondary DAs can be sourced from a child's primary DAs. In such case, the separate knowledge graphs of both the parent and child that can be made aware of each other to inform syndication decisions.

In some example embodiments, secondary DAs with matching time and location to moments already identified in the primary photo library are deemed eligible secondary DAs. This content promotion is intended to identify secondary DAs from locations where the user was present, and allow completion of a corresponding Memory in the primary photo library.

In some example embodiments, secondary DAs with matching time and device location within a time interval (e.g. the last month) are deemed eligible secondary DAs. This content promotion option leverages location data and is intended to identify secondary DAs from locations where the user has recently been. Along with the location data, a secondary DAs data/location is used to determine if there is a match to within an acceptable tolerance between end-user device location/data and secondary DA location/data. One example scenario for this content promotion option relates a group setting (e.g., a lunch with colleagues) in which the user was present at the location and thus secondary DAs with or without the user visible are deemed eligible.

In some example embodiments, secondary DAs with matching time and person relative to moments in primary photo library are deemed eligible secondary DAs. This content promotion option is intended to identify secondary DAs of relevant people and Memories that are already in the primary photo library. Not only does the person need to be present in the primary photo library, but the person should also be present in the same moment in time. For example, a secondary DA of a best friend from two years ago will not automatically be deemed eligible unless other photos of the best friend from the same moment are already present in the primary photo library.

In some example embodiments, secondary DAs with matching time and pet to a moment already in the primary photo library are deemed eligible secondary DAs. This content promotion option is intended to identify secondary DAs of pets related to moments that are already in the primary photo library. Note: since secondary DAs do not have the complete context of the primary photo library and its associated knowledge graph, matching people/pets of secondary DAs with people/pets already in the primary photo library may rely on facial recognition and matching.

Once the eligible secondary DAs are identified and linked to the primary photo library, curation queries of the primary photo library will include the eligible secondary DAs. In some example embodiments, the eligible secondary DAs are not promoted for use as cover photos for Memories (unless there is no other option), but a Memory can include these eligible secondary DAs. As desired, eligible secondary DAs are also selectable as a featured DA of the primary photo library.

In addition to participating in the regular experience of building/curating Memories, the including of eligible secondary DAs in the primary photo library can act as a trigger or request to find or construct a contextually relevant Memory for immediate display to a user. For example, if a user meets a past colleague for lunch and the colleague sends the user a photo from their university days, a Memory could be immediately generated for the user containing DAs from moments in the user's primary photo library from past interactions with the colleague.

For content like Memories, albums, other DA collections, which may include eligible secondary DAs, user may be prompted to save DAs into their primary photo library before the respective DAs can be shared with others or synced to other devices. This is due to the fact that eligible secondary DAs are likely to only be present on the end-user device on which they were received.

Together the quality filtration stage, the content promotion stage, or other eligibility filters 126 enables a DA management system to find relevant content to participate as guest DAs in the primary photo library. The described DA management system 100 is usable with texting/messaging applications of an end-user device, including third-party applications with a messaging features.

In some example embodiments, the secondary DA syndication instructions 124 cause the processing units(s) 104 to: identify DAs on an end-user device and received from another device as secondary DAs; add the secondary DAs to a syndication library separate from the primary photo library; apply eligibility filters to the secondary DAs in the syndication library, the eligibility filters resulting in a set of eligible secondary DAs in the syndication library and a set of ineligible secondary DAs in the syndication library; and link the set of eligible secondary DAs in the syndication library with the primary photo library. In some example embodiments, the content of messaging applications is analyzed or scraped to automate identifying the secondary digital assets. The linking of the set of eligible secondary DAs includes, for example, updating a knowledge graph or linking multiple knowledge graphs. Once linked, the set of eligible secondary DAs is available for query, organization, and featured DA options of the primary photo library. In some example embodiments, the set of eligible secondary DAs is displayed in the primary photo library; and the updated knowledge graph or linked knowledge graphs is used when performing primary photo library options to organize and feature DAs.

In some example embodiments, applying the eligibility filters to the secondary digital assets in the syndication library includes: applying scores to the secondary digital assets in the syndication library, the scores providing an indication of quality relative to at least one quality metric; identifying a first set of secondary digital assets in the syndication library with scores above a threshold; and identifying a second set of secondary digital assets in the syndication library with scores at or below the threshold, the second set of secondary digital assets included with the set of ineligible secondary digital assets in the syndication library. In some example embodiments, the applied scores account for an aesthetic quality metric and a document or meme exclusion metric. In some example embodiments, applying the eligibility filters to the secondary digital assets in the syndication library includes applying a file type filter and a workplace eligibility filter. In some example embodiments, applying the eligibility filters to the secondary digital assets in the syndication library includes matching digital asset identifiers or metadata identifiers with predetermined identifiers associated with digital assets already in the primary photo library. Without limitation, the predetermined identifiers may include faces, pets, locations, and times.

As shown, the computer-readable memory 110 may store and/or retrieve DA metadata 112, the knowledge graphs 114, and/or optional data 116 described by or associated with the DA metadata 112. The DA metadata 112, the knowledge graphs 114, and/or the optional data 116 can be generated, processed, and/or captured by the other components in the system 100. For example, the DA metadata 112, the knowledge graphs 114, and/or the optional data 116 may include data generated by, captured by, processed by, or associated with one or more peripherals 118, the DA capture device (s) 102, or the processing unit(s) 104, etc. The system 100 can also include a memory controller (not shown), which includes at least one electronic circuit that manages data flowing to and/or from the computer-readable memory 110. The memory controller can be a separate processing unit or integrated in processing unit(s) 104.

In some example embodiments, the DA capture device(s) 102 is an imaging device for capturing images, an audio device for capturing sounds, a multimedia device for capturing audio and video, any other known DA capture device. The DA capture device(s) 102 is illustrated with a dashed box to show that it is an optional component of the system 100. In one embodiment, the DA capture devices) 102 can also include a signal processing pipeline that is implemented as hardware, software, or a combination thereof. The signal processing pipeline can perform one or more operations on data received from one or more components in the DA capture device(s) 102. The signal processing pipeline can also provide processed data to the computer-readable memory 110, the peripheral(s) 118 (as discussed further below), and/or the processing unit(s) 104.

The peripheral(s) 118 can include at least one of the following: (i) one or more input devices that interact with or send data to one or more components in the system 100 (e.g., mouse, keyboards, etc.); (ii) one or more output devices that provide output from one or more components in the system 100 (e.g., monitors, printers, display devices, etc.); or (iii) one or more storage devices that store data in addition to the computer-readable memory 110. Peripheral(s) 118 is illustrated with a dashed box to show that it is an optional component of the system 100. The peripheral(s) 118 may also refer to a single component or device that can be used both as an input and output device (e.g., a touch screen, etc.). The system 100 may include at least one peripheral control circuit (not shown) for the peripheral(s) 118. The peripheral control circuit can be a controller (e.g., a chip, an expansion card, or a stand-alone device, etc.) that interfaces with and is used to direct operation(s) performed by the peripheral(s) 118. The peripheral(s) controller can be a separate processing unit or integrated in processing unit(s) 104. The peripheral(s) 118 can also be referred to as input/output (I/O) devices 118 throughout this document.

As shown, the system 100 also include one or more sensors 122, which are illustrated with a dashed box to show that the sensors 122 are optional components of the system 100. For one embodiment, the sensor(s) 122 can detect a characteristic of one or more environs. Examples of a sensor include, but are not limited to: a light sensor, an imaging sensor, an accelerometer, a sound sensor, a barometric sensor, a proximity sensor, a vibration sensor, a gyroscopic sensor, a compass, a barometer, a heat sensor, a rotation sensor, a velocity sensor, and an inclinometer.

In the example of FIG. 1, the system 100 includes a communication mechanism 120. The communication mechanism 120 can be, e.g., a bus, a network, or a switch. When the technology 120 is a bus, the technology 120 is a communication system that transfers data between components in system 100, or between components in system 100 and other components associated with other systems (not shown). As a bus, the technology 120 includes all related hardware components (wire, optical fiber, etc.) and/or software, including communication protocols. For one embodiment, the technology 120 can include an internal bus and/or an external bus. Moreover, the technology 120 can include a control bus, an address bus, and/or a data bus for communications associated with the system 100. For one embodiment, the technology 120 can be a network or a switch. As a network, the technology 120 may be any network such as a local area network (LAN), a wide area network (WAN) such as the Internet, a fiber network, a storage network, or a combination thereof, wired or wireless. When the technology 120 is a network, the components in the system 100 do not have to be physically co-located. When the technology 110 is a switch (e.g., a “cross-bar” switch), separate components in system 100 may be linked directly over a network even though these components may not be physically located next to each other. For example, two or more of the processing unit(s) 104, the communication technology 120, the computer-readable memory 110, the peripheral(s) 118, the sensor(s) 122, and the DA capture device 102 are in distinct physical locations from each other and are communicatively coupled via the communication technology 120, which is a network or a switch that directly links these components over a network.

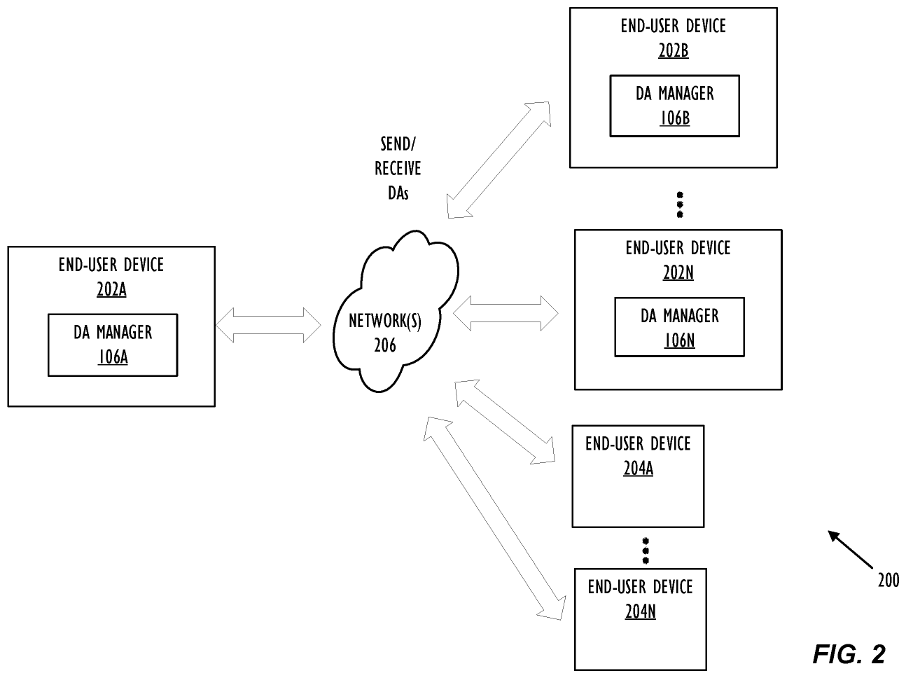

FIG. 2 illustrates, in block diagram form, a system 200 with networked end-user devices in accordance with an embodiment. In the system 200, the end-user devices 202A-202N include respective DA managers 106A-106N, and may include a DA management system (e.g., the DA management system in FIG. 1). The system 200 may also include end-user devices 204A-204N without DA managers or with legacy DA managers that lack syndication of secondary DAs as described herein. In the system 200, DAs may be sent and received between the end-user devices 202A-202N and 204A-204N via network(s) 206 and respective messaging applications. The network(s) 206 include wired and/or wireless communication interfaces. In some example embodiments, the network(s) 206 provide cloud storage and/or computing options for the end-user devices 202A-202N and 204A-204N. Over time, the number of secondary DAs stored by each of the end-user device 202A-202N and 204A-204N generally increases. Some of the secondary DAs will be more meaningful to the user of a given end-user device, while others are less meaningful. In the end-user devices 204A-204N, secondary DAs may be accessible in a primary photo library using a tedious manual process and related user interface. In contrast, the end-user devices 202A-202N with respective DA managers 106A-106N perform automated syndication of secondary DAs with their respective primary photo libraries as described herein.

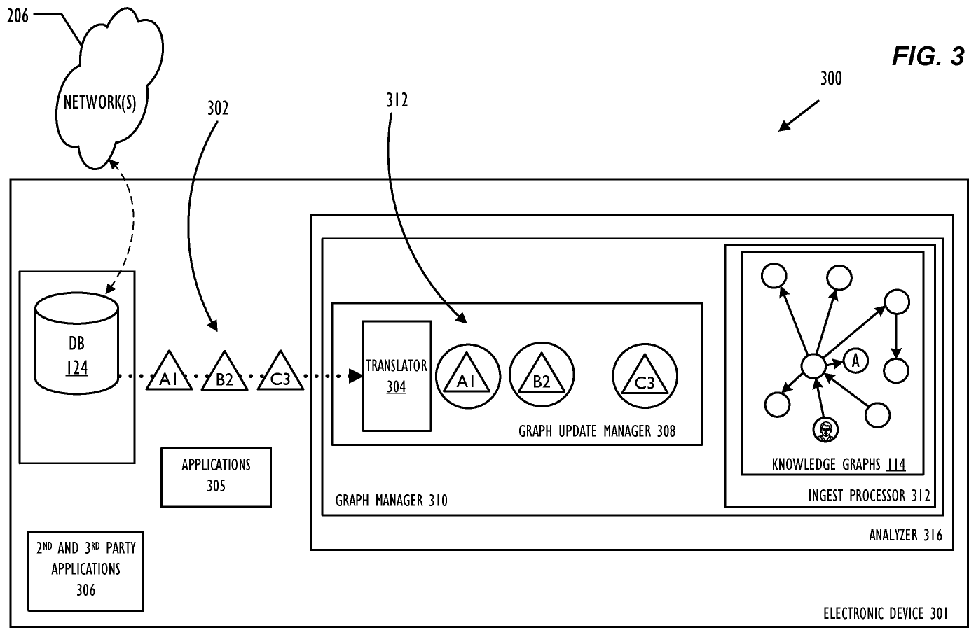

FIG. 3 illustrates an architecture 300 for updating knowledge graphs 114 by a DA management system (e.g., the DA management system 100 in FIG. 1) based on changes in a relational database 124. In the example of FIG. 3, the architecture 300 includes an electronic device 301 (e.g., one of the end-user devices 202A-202N with respective DA managers 106A-106N) in communication with network(s) 206. In some example embodiments, with the architecture 300, the knowledge graphs 114 are updated periodically (e.g., a twenty-four hour cycle) with changes in the relational database being considered in series. Updating in this manner can involve making changes to knowledge graphs 114 that do not need to be made immediately, such as updates to an event node due to a change in the relational database 124. It is also possible to attempt to update knowledge graphs 114 every time a change is made to the relational database 124. However, in many cases it can be preferable to consider a batch or group of change notifications 302 from the relational database 124 collectively. Doing so can, as explained in greater detail below, enable a DA processing system to ignore changes (e.g., B2) which are, for example, redundant in light of a subsequent change (e.g., A1). This functionality is provided by the translator 304. The translator 304 is a translational layer of a DA management system. The manner in which the translator 302 chooses updates is encoded in code and executed by one or more processing units 104.

As noted previously, knowledge graphs 114 responds to updates, modifications, and changes that occur in the relational database 124. The relational database 124 is thus separate from the knowledge graphs 114. The relational database 124 supports functionality of various native applications 305 (such as a photos application) as well as second-party and third-party applications 306. All of the asset data is maintained in the relational database 124. Changes in the data stored by the relational database 124 can be brought about by interactions with the applications 304, 306, and with the network(s) 204 (e.g., supporting data transfers between end-user devices, cloud storage/computing options, etc.). The knowledge graphs 114 can often respond in real time to changes in the relational database 124. This real time responsiveness is enabled, in part, by culling changes in the relational database which do not necessitate a modification, change, or update within the knowledge graphs 114. The translator 204 can also manage the situation in which change (e.g. C3) is currently being implemented and additional change notifications (e.g., A1 and B2) are received by the graph update manager 308. Such changes are buffered and be processed in batches. Buffering change notifications and separating the redundant and/or cumulative and/or irrelevant changes reduces the computational intensity to implement such changes in the knowledge graph 114 than would otherwise by the case.

The better management of relational database 124 provides a finer grain data stream, which makes it possible to be more circumspect or targeted as to what changes will be translated into updates by the translator 304. The translator 304 component of the graph manager 310 can identify certain changes that come from the relational database 124 that are not relevant to the knowledge graphs 114. For example, in one embodiment the knowledge graphs 114 does not track ‘albums’ data objects used by a photos application (e.g., one of the applications 305) and stored by the relational database 124.

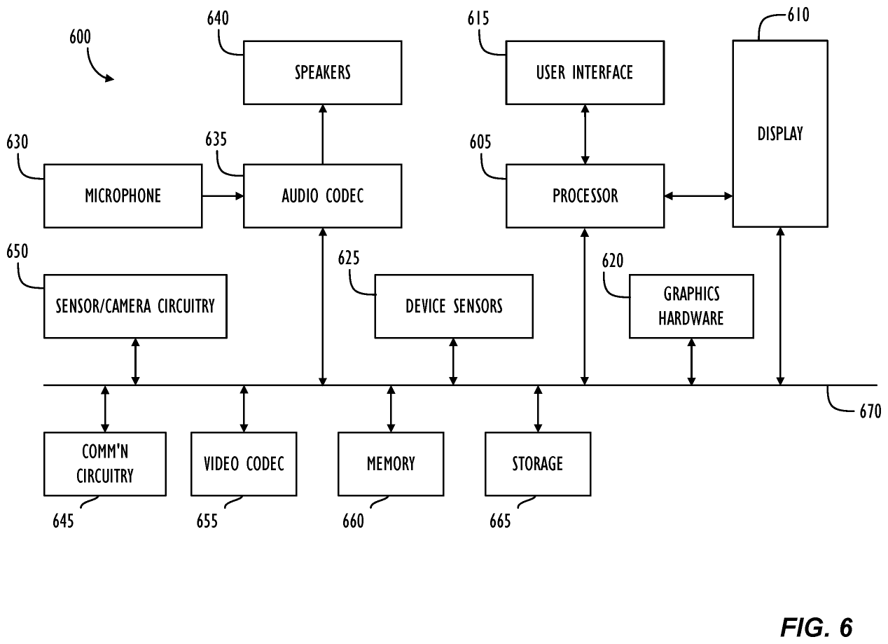

The translator 304 can also make distinctions at a property level (fields within an object). For example, the translator translates changes to certain media assets, but not all changes to those media assets. For example, there can be states that relational database 124 needs in order to keep track of assets, but that have no bearing on the nodes and edges of the knowledge graph 114. The translator 204 can note the properties of an object that have changed and determine whether those properties could affect changes in the nodes or edges in the knowledge graph 114, and thereby only translate those property changes which would do so. This is an example of the translator making a determination as to whether change(s) in a relational database which are detected warrant making corresponding modifications to information in one or more graph networks. Another example of when a change would not warrant an update is when a subsequent change (both under consideration by the translator component) negates it. For example, if it is shown in the relational database that a person has friended, and then unfriended, another person, it would serve no purpose to note the friendship status only to immediately remove/overwrite it When not unwarranted (i.e., warranted), the translator 304 translates the detected changes 302 into graph update specifications and/or modification instructions 312. The ingest processor 312 receives and applies the modification instructions 312 to the knowledge graphs 114. The graph manager 310 and its subcomponents are hosted by the analyzer (daemon) 316 within an electronic device (see e.g., the electronic device 600 of FIG. 6).

In an embodiment, the nodes and edges of the knowledge graphs 124 are considered in two main levels: there are the node primitives: moment, person, date and location; and there are more abstract higher level nodes which are derived from the primitives. The moment, person, date and location can be driven, updated and managed directly based on changes coming directly from the relational database objects. Social groups are collections of person nodes within the knowledge graph 124. The knowledge graphs 114 infer the existence of the social group, though the social group has no counterpart in the relational database 124. The social group can be very large and have many person nodes, each of which may have multiple relationships (edges) with other nodes. Thus changing a single property of a node (based on a change in a property of an object) in the relational database 124 can necessitate a large number of modifications to the knowledge graphs 114. In an embodiment, the translator 304 can determine, based on computational expense, which changes to translate more immediately and which changes to delay. In another embodiment, the translator 304 provides input to a set of post processing steps (not shown) that are responsible for taking the graph update specification(s) 312 generated by the translator 304 and using the specification(s) 312 along with updated knowledge graphs 114 (i.e. the knowledge graphs 114 after updates by the translator 314 are applied) to produce additional updates to the high-level nodes in the knowledge graphs 114.

In one example, the translator 304 may receive a notice indicating that a new object, such as a moment object, has been created. The translator 304 might then receive notice that a location property of the moment object has changed, and thereafter that the time property of the moment object. In order to save time and computational expense, the new moment object can be added to the knowledge graph 124 with all three properties at once. In some cases, even with such consolidation, some updates to the knowledge graph 124 can be computationally expensive. It can take time to evaluate what aspects of the nodes need to be updated, especially in terms of relationships. A person object could have its name property changed, (perhaps a user of the electronic device that includes a DA management system might realize he had misspelled his wife's name, and decide to correct it). A person node corresponding to that object may have faces distributed across multiple moment nodes. It can be expensive to all of such moment nodes. In that case, a DA management system can do a fast update to record the fact in a person node that the name has been changed, but without immediately working out all of the details of relationships in the knowledge graphs 114 that might be affected.

In some example embodiments, the knowledge graphs 114 maintained and updated using the architecture 300 may include a primary DA knowledge graph 117 and a secondary DA knowledge graph 119. Initially, secondary DAs are not linked to the primary photo library of an end-user device as are primary DAs. Instead, the secondary DAs are part of a syndication library related to secondary DA knowledge graph 119. The secondary DAs in the syndication library are subject to syndication operations performed by a DA manager (e.g., the DA manager 106 in FIG. 1, or one of the DA managers 106A-106N in FIG. 2) to determine which secondary DAs are to be associated with the primary photo library. During syndication operations, a given DA manager may use the primary DA knowledge graph 117 and the secondary DA knowledge graph 119, which are updated as needed using the architecture 300 of FIG. 3. The syndication operations may be performed using a schedule or in response to a syndication trigger (e.g., a user or application request).

FIG. 4 illustrates, in block diagram form, a primary photo library scenario 400, in accordance with an embodiment. In the example of FIG. 4, the primary photo library scenario 400 includes a primary photo library 402 corresponding to cloud-based photos (e.g., photos uploaded from an end-user device to a user account) and/or a local photo library, where the primary photo library 402 is accessible via a photo library interface 404. The photo library interface 404 (e.g., the PhotoKit interface from Apple Inc.) provides classes that support building photo-editing extensions for the primary photo library of an end-user device. For different operating systems (e.g., iOS®, macOS®, and tvOS® operating systems, of which iOS is a registered trademark of Cisco Technology Inc., and macOS and tvOS are registered trademarks of Apple Inc.), the photo library interface 404 also provides direct access to the DAs managed by the photos application. Example operations 410 that are handled by the photo library interface 404 include fetching and caching assets of the primary photo library 402 for display and playback, editing image and video content, or managing collections of assets such as albums or shared albums. Example projects 408 supported by the photo library interface 404 include prints, slideshows, books, calendars, moments, and wall décor. In some example embodiments, the photo library interface 404 includes or is in communication with a DA manager 404 configured to perform syndication of secondary DAs as described herein. With the syndication operations, secondary DAs are initially excluded from being linked or associated with the primary photo library 402. The syndication process filters the secondary DAs and establishes a set of eligible secondary DAs. After syndication, the set of eligible secondary DAs are linked with primary photo library 402 and are available query, organization, and featured DA options related to operations 410 and/or other operations.

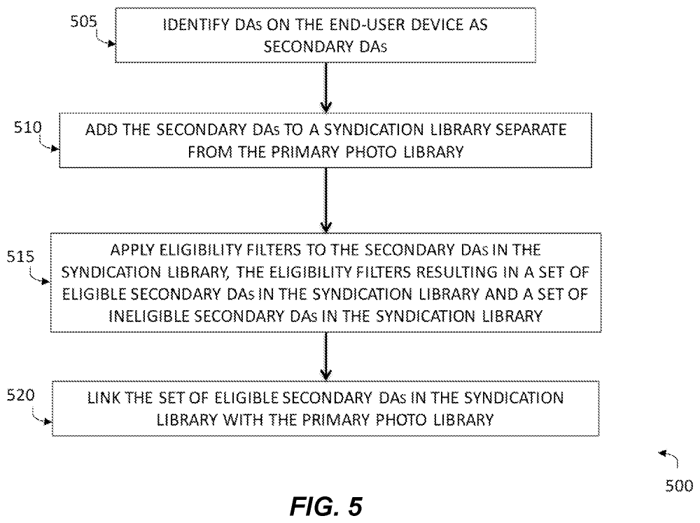

FIG. 5 illustrates, in flowchart form, a method 500 of managing syndication of secondary digital assets with a primary photo library of an end-user device in accordance with an embodiment. The method 500 is performed, for example, by a DA management system (e.g., the DA management system 100 in FIG. 1, one of the end-user devices 202A-202N in FIG. 2, or the electronic device 301). As shown, the method 500 includes identifying DAs on the end-user device and/or received from another device as secondary DAs at block 505. At block 510, the secondary DAs are added to a syndication library separate from the primary photo library. At block 515, eligibility filters are applied to the secondary DAs in the syndication library, the eligibility filters resulting in a set of eligible secondary DAs in the syndication library, and a set of ineligible secondary DAs in the syndication library. In some example embodiments, applying the eligibility filters to the secondary digital assets in the syndication library at block 515 includes: applying scores to the secondary digital assets in the syndication library, the scores providing an indication of quality relative to at least one quality metric; identifying a first set of secondary digital assets in the syndication library with scores above a threshold; and identifying a second set of secondary digital assets in the syndication library with scores at or below the threshold, the second set of secondary digital assets included with the set of ineligible secondary digital assets in the syndication library. In some example embodiments, the applied scores account for an aesthetic quality metric and/or a document or meme exclusion metric. In some example embodiments, applying the eligibility filters to the secondary digital assets in the syndication library at block 515 includes applying a file type filter and/or a workplace eligibility filter. In some example embodiments, applying the eligibility filters to the secondary digital assets in the syndication library at block 515 includes matching digital asset identifiers or metadata identifiers with predetermined identifiers associated with digital assets already in the primary photo library. The predetermined identifiers include faces, pets, locations, times, and/or other predetermined identifiers.

At block 520, the set of eligible secondary DAs in the syndication library is linked with the primary photo library. Once linked to the primary photo library, the set of eligible secondary DAs is included with features of the primary photo library such as query, organization, and featured DA options. The set of ineligible secondary DAs in the syndication library may still be accessible to a user via an interface for the syndication library, but these ineligible secondary DAs are not automatically linked to the primary photo library. In some example embodiments, the ineligible secondary DAs in the syndication library may still be manually selected by a user for inclusion in the primary photo library. In other example embodiments, manual selection of ineligible secondary DAs for inclusion in the primary photo library is not possible.

In some example embodiments, the method 500 includes analyzing content of messaging applications to identify the secondary DAs. In some example embodiments, the method 500 includes linking the set of eligible secondary digital assets includes updating a knowledge graph or linking multiple knowledge graphs. In some example embodiments, the method 500 includes: displaying the set of eligible secondary digital assets in the primary photo library; and using the updated knowledge graph or linked knowledge graphs when performing primary photo library options to organize and feature digital assets.

Referring now to FIG. 6, a simplified functional block diagram of an illustrative programmable electronic device 600 for performing DA management is shown, according to one embodiment. The electronic device 600 could be, for example, a mobile telephone, personal media device, portable camera, or a tablet, notebook or desktop computer system, as well as a wearable computing device such as a smart watch. As shown, electronic device 600 may include a processor 605, a display 610, a user interface 615, a graphics hardware 620, device sensors 625 (e.g., proximity sensor/ambient light sensor, accelerometer and/or gyroscope), a microphone 630, audio codec(s) 635, speaker(s) 640, communications circuitry 645, image capture circuit or unit 650, which may, e.g., comprise multiple camera units/optical sensors having different characteristics (as well as camera units that are housed outside of, but in communication with the electronic device 600), video codec(s) 655, computer-readable memory 660, storage 665, and communications bus 670.

The processor 605 may execute instructions necessary to carry out or control the operation of many functions performed by the electronic device 600 (e.g., such as the generation and/or processing of DAs in accordance with the various embodiments described herein). The processor 605 may, for instance, drive the display 610 and receive user input from the user interface 615. The user interface 615 can take a variety of forms, such as a button, keypad, dial, a click wheel, keyboard, display screen and/or a touch screen. The user interface 615 could, for example, be the conduit through which a user may view a captured video stream and/or indicate particular images(s) that the user would like to capture or share (e.g., by clicking on a physical or virtual button at the time that the desired image is being displayed on the device's display screen).

In one embodiment, the display 610 may display a video stream as it is captured while the processor 605 and/or the graphics hardware 620 and/or image capture circuitry contemporaneously store the video stream (or individual image frames from the video stream) in the computer-readable memory 660 and/or the storage 665. The processor 605 may be a system-on-chip such as those found in mobile devices and include one or more dedicated graphics processing units (GPUs). The processor 605 may be based on reduced instruction-set computer (RISC) or complex instruction-set computer (CISC) architectures or any other suitable architecture and may include one or more processing cores. The graphics hardware 620 may be special purpose computational hardware for processing graphics and/or assisting processor 605 perform computational tasks. In one embodiment, graphics hardware 620 may include one or more programmable graphics processing units (GPUs).

The image capture circuitry 650 may comprise one or more camera units configured to capture images, e.g., images which may be managed by a DA management system. Output from the image capture circuitry 650 may be processed, at least in part, by the video codec(s) 655 the processor 605, the graphics hardware 620, and/or a dedicated image processing unit incorporated within circuitry 650. Images so captured may be stored in the computer-readable memory 660 and/or the storage 665. The computer-readable memory 660 may include one or more different types of media used by the processor 605, the graphics hardware 620, and the image capture circuitry 650 to perform device functions. For example, the computer-readable memory 660 may include memory cache, read-only memory (ROM), and/or random access memory (RAM). The storage 665 may store media (e.g., audio, image and video files), computer program instructions or software, preference information, device profile information, and any other suitable data. The storage 665 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). The computer-readable memory 660 and the storage 665 may be used to retain computer program instructions or code organized into one or more modules and written in any desired computer programming language. When executed by, for example, the processor 605, such computer program code may implement one or more of the methods described herein.

For clarity of explanation, the embodiment of FIG. 6 is presented as including individual functional blocks including functional blocks labeled as the processor 605 or the graphics hardware 620. The functions these blocks represent may be provided through the use of either shared or dedicated hardware, including, but not limited to, hardware capable of executing software and hardware, such as the processor 605 or the graphics hardware 620, that is purpose-built to operate as an equivalent to software executing on a general purpose processor. For example the functions of one or more processors presented in FIG. 6 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) for storing software performing the operations discussed below, and random access memory (RAM) for storing results, both of which may be subsumed within the computer-readable memory 660. Very large scale integration (VLSI) hardware embodiments, as well as custom VLSI circuitry in combination with a general purpose DSP circuit, may also be provided.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although operations or methods have been described above in terms of some sequential operations, it should be appreciated that some of the operations described may be performed in a different order. Moreover, some operations may be performed in parallel, rather than sequentially. Embodiments described herein are not described with reference to any particular programming language. It will be appreciated that a variety of programming languages may be used to implement the various embodiments of the disclosed subject matter. In utilizing the various aspects of the embodiments described herein, it would become apparent to one skilled in the art that combinations, modifications, or variations of the above embodiments are possible for managing components of a processing system to increase the power and performance of at least one of those components.

As described above, one aspect of the present technology is the gathering and use of data available from various sources to improve the ability of users to manage and search for the information that is related to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to enable users to more quickly locate information for which they have an interest, and by extension the present disclosure enables users to have more streamlined and meaningful control of the content and information (personal and otherwise) that they share with others. Further, other uses for personal information data that benefit the user are also contemplated by the present disclosure. For instance, health and fitness data may be used to provide insights into a user's general wellness, or state of well-being during various moments or events in their lives.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries or regions may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of data asset management services, the present technology can be configured to allow users to select to “opt in” or “opt out” of participation in the collection of personal information data during registration for services or anytime thereafter. In another example, users can select not to provide their content and other personal information for inclusion in graph databases of others. In yet another example, users can select to limit the length of time their personal information data is maintained by a third party and/or entirely prohibit the development of a knowledge graph or other metadata profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be suggested for sharing to users by inferring preferences based on non-personal information data or a bare minimum amount of personal information within a user's relational database, such as the quality level of the content (e.g., focus, exposure levels, etc.) or the fact that certain content is being requested by a device associated with a contact of the user, other non-personal information available to the DA management system, or publicly available information.

It is to be understood that the above description is intended to be illustrative, and not restrictive. The material has been presented to enable any person skilled in the art to make and use the invention as claimed and is provided in the context of particular embodiments, variations of which will be readily apparent to those skilled in the art (e.g., many of the disclosed embodiments may be used in combination with each other). In addition, it will be understood that some of the operations identified herein may be performed in different orders. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

We claim:

1. A method of managing syndication of secondary digital assets with a primary photo library of an end-user device, the method comprising:
identifying digital assets on the end-user device and received from another device as the secondary digital assets;
adding the secondary digital assets to a syndication library separate from the primary photo library;
applying eligibility filters to the secondary digital assets in the syndication library, the eligibility filters resulting in a set of eligible secondary digital assets in the syndication library and a set of ineligible secondary digital assets in the syndication library; and
linking the set of eligible secondary digital assets in the syndication library with the primary photo library.

2. The method of claim 1, further comprising analyzing content of messaging applications to identify the secondary digital assets.

3. The method of claim 1, wherein linking the set of eligible secondary digital assets includes updating a knowledge graph or linking multiple knowledge graphs.

4. The method of claim 3, further comprising:
displaying the set of eligible secondary digital assets in the primary photo library; and
using the updated knowledge graph or linked knowledge graphs when performing primary photo library options to organize and feature digital assets.

5. The method of claim 1, wherein applying the eligibility filters to the secondary digital assets in the syndication library includes:
applying scores to the secondary digital assets in the syndication library, the scores providing an indication of quality relative to at least one quality metric;
identifying a first set of secondary digital assets in the syndication library with scores above a threshold; and
identifying a second set of secondary digital assets in the syndication library with scores at or below the threshold, the second set of secondary digital assets included with the set of ineligible secondary digital assets in the syndication library.

6. The method of claim 5, wherein applied scores account for an aesthetic quality metric and a document or meme exclusion metric.

7. The method of claim 1, wherein applying the eligibility filters to the secondary digital assets in the syndication library includes applying a file type filter and a workplace eligibility filter.

8. The method of claim 1, wherein applying the eligibility filters to the secondary digital assets in the syndication library includes matching digital asset identifiers or metadata identifiers with predetermined identifiers associated with digital assets already in the primary photo library.

9. The method of claim 8, wherein the predetermined identifiers include faces, pets, locations, and times.

10. A computer-readable medium comprising instructions that, when executed, configure a processor to:
identify digital assets on the end-user device and received from another device as secondary digital assets;
add the secondary digital assets to a syndication library separate from a primary photo library;
apply eligibility filters to the secondary digital assets in the syndication library, the eligibility filters resulting in a set of eligible secondary digital assets in the syndication library and a set of ineligible secondary digital assets in the syndication library; and
linking the set of eligible secondary digital assets in the syndication library with the primary photo library.

11. The computer-readable medium of claim 10, wherein the instructions, when executed, configure a processor to:
link the set of eligible secondary digital assets with the primary photo library by updating a knowledge graph or linking multiple knowledge graphs;
display the set of eligible secondary digital assets in the primary photo library; and
use the updated knowledge graph or linked knowledge graphs to perform primary photo library options to organize and feature digital assets.

12. The computer-readable medium of claim 10, wherein the instructions, when executed, configure a processor to apply the eligibility filters to the secondary digital assets in the syndication library by:
applying scores to the secondary digital assets in the syndication library, the scores accounting for an aesthetic quality metric and a document or meme exclusion metric;
identifying a first set of secondary digital assets with scores above a threshold; and
identifying a second set of secondary digital assets with scores at or below the threshold, the second set of secondary digital assets included with the set of ineligible secondary digital assets in the syndication library.

13. The computer-readable medium of claim 10, wherein the instructions, when executed, configure a processor to apply the eligibility filters to the secondary digital assets in the syndication library by:
applying a file type filter; and
applying a workplace eligibility filter.

14. The computer-readable medium of claim 10, wherein the instructions, when executed, configure a processor to apply the eligibility filters to the secondary digital assets in the syndication library by matching digital assets identifiers or metadata identifiers with predetermined identifiers associated with digital assets in the primary photo library, the predetermined identifiers including faces, pets, locations, and times.

15. A system comprising:
one or more processors;
one or more sensors configured to capture digital assets;
a memory for storing program instructions for the one or more processors, where the instructions, when executed, cause the one or more processors to:
maintain a primary photo library based on the primary digital assets,
identify digital assets received from another device as secondary digital assets;
add the secondary digital assets to a syndication library separate from the primary photo library;
apply eligibility filters to the secondary digital assets in the syndication library, the eligibility filters resulting in a set of eligible secondary digital assets in the syndication library and a set of ineligible secondary digital assets in the syndication library;
select at least some of the first set of secondary digital assets for inclusion in the primary photo library; and
link the set of eligible secondary digital assets in the syndication library with the primary photo library.

16. The system of claim 15, wherein the instructions, when executed, further cause the one or more processors to:
link the set of eligible secondary digital assets with the primary photo library by updating a knowledge graph or linking multiple knowledge graphs;
display the set of eligible secondary digital assets in the primary photo library; and
use the updated knowledge graph or linked knowledge graphs to perform primary photo library options to organize and feature digital assets.

17. The system of claim 15, wherein the instructions, when executed, further cause the one or more processors to apply the eligibility filters to the secondary digital assets in the syndication library by:
applying scores to the secondary digital assets in the syndication library, the scores accounting for an aesthetic quality metric and a document or meme exclusion metric;
identifying a first set of secondary digital assets with scores above a threshold; and
identifying a second set of secondary digital assets with scores at or below the threshold, the second set of secondary digital assets included with the set of ineligible secondary digital assets in the syndication library.

18. The system of claim 15, wherein the instructions, when executed, further cause the one or more processors to apply the eligibility filters to the secondary digital assets in the syndication library by:
applying a file type filter; and
applying a workplace eligibility filter.

19. The system of claim 15, wherein the instructions, when executed, further cause the one or more processors to apply the eligibility filters to the secondary digital assets in the syndication library by matching digital assets identifiers or metadata identifiers with predetermined identifiers associated with digital assets in the primary photo library, the predetermined identifiers including faces, pets, locations, and times.

20. The system of claim 15, wherein the instructions, when executed, further cause the one or more processors to analyze content of messaging applications to identify the secondary digital assets.
